(19) United States
(12) Patent Application Publication
(10) Pub. No.: US 2004/0178983 A1
(43) Pub. Date: Sep. 16, 2004

(54) Compensation device and method for a display gate driver circuit

(75) Inventors: Ming-Wei Tsai, Jungli City (TW); Mu-Shan Liao, Shijou Shiang (TW)

Correspondence Address: TROXELL LAW OFFICE PLLC, SUITE 1404, 5205 LEESBURG PIKE, FALLS CHURCH, VA, 22041, US

(73) Assignee: CHUNGHWA PICTURE TUBES, LTD.

(21) Appl. No.: 10/458,312

(22) Filed: Jun. 11, 2003

(30) Foreign Application Priority Data
Mar. 14, 2003 (TW) 092105716

(51) Int. Cl. G09G 3/36

(52) U.S. Cl. 345/100

(57) ABSTRACT

The present invention relates to a compensation device and method for a display gate driver circuit. This compensation circuit is used for compensating the voltage droppings among a plurality of gate driver chips in a liquid crystal display (LCD) panel due to the resistances so as to avoid the appearance of block dims on the display panel caused by the inconsistence of the voltage droppings. A gate driver circuit front compensation device of the LCD panel includes a compensation circuit composed of a timing controller, a trigger generator, a starter circuit and a power converter.

### BACKGROUND OF THE INVENTION

1. Field of the Invention

The present invention relates a display gate driver circuit and driving method. A compensation circuit is employed for compensating the voltage droppings among a plurality of gate driver chips in a LCD panel caused by the resistances, so as to avoid the appearance of block dims on the display panel due to the inconsistence of the voltage droppings.

2. Description of the Prior Art

In the prior art LCD panel, if gate driver chips are not installed on a printed wiring board (PWB), then this scheme will employ a chip-on-film (COF) method, relating to the technology of bonding the flip chips on a flexible printed circuit (FPC) board, so as to directly install the gate driver chips and the electrical elements on a film (such as a glass panel) of the LCD panel. This will make the conventional printed circuit board not required so as to reduce the size and the manufacturing cost.

However, when manufacturing the gate driver chips by employing the chip-on-film method to bond the chips on the film (such as a glass baseboard or a plastic board), the wiring of the signal and power lines will make the resistances generated so that the voltage differences will generated among the gate driver chips (namely, the divided voltages assigned to each of the gate driver chips are different) when the TFT at each of the gate input ends on the LCD panel performing the switching operations.

Besides, the coupling capacitance will be generated between the signal line and the scan line on the LCD panel, and the relation among the coupling capacitance (C) between the data line and the scan line, the current (I), the liquid crystal gate driving voltage (dV) and the scan line time (dt) is the equation of I=C(dV/dt). Please refer to FIG. 1 FIG. 1 is a perspective diagram of a prior art gate driver circuit. There are three gate driver chips (practically, it is not limited to the three ones) are installed on the LCD panel 15, and they are a first gate driver chip 11, a second gate driver chip 12 and a third gate driver chip 13. The plurality of gate driver chips will sequentially initiate the scan lines 18, and a data driver 14 will initiate the signal line 19 so as to send out a signal to turn on each of the TFT switches 16. On the TFT liquid crystal display, each of the pixels is corresponding to each of the TFT switches 16 so that the TFT will charge/discharge the storing capacitance of the display pole (the display liquid crystal LCD). Therefore, when the wiring of each of the gate driver chips 11, 12, 13 sends out a voltage to turn on each of the TFT switches 16, because of the equation of current I=C(dV/dt), the preceding TFT switch 16 will affect the driving of the next TFT switch 16 so as to affect the liquid crystal driving voltage of the whole LCD panel 15. This will make the greater current on some frames flow to each of the gate driver chips from the scan line 18 so as to affect the voltage value of the storing capacitance on the TFT switch 16.

In addition, when the scan line 18 sequentially turn on the storing capacitance on each of the TFT switches 16, a great feedback current will be generated at the end of the gate driver chip so that the resistance voltage dropping will be generated in the circuit installed on the LCD panel 15 made of glass material. This will make different resistance values generated for the gate driver chips 11, 12, 13, and make each of the gate driver chip ends have different driving voltage. As shown in FIG. 1, the resistances caused by the wiring will make the different driving voltages generated for the first gate driver chip 11, the second gate driver chip 12 and the third gate driver chip 13 so as to cause different affects to the display liquid crystal and result in the appearance of the block dims on the LCD panel 15.

In order to improve the drawbacks of the prior art, a compensation driver circuit is installed in the front of a plurality of gate driver chips so as to compensate the voltage droppings of the driving voltages. This will avoid the appearance of the block dims on the display.

### SUMMARY OF THE INVENTION

The present invention relates to a compensation device and method for a display gate driver circuit. This compensation circuit is used for compensating the voltage droppings among a plurality of gate driver chips in a liquid crystal display (LCD) panel due to the resistances, so as to avoid the appearance of block dims on the display panel caused by the inconsistence of the voltage droppings. The gate driver circuit front compensation device of the LCD panel includes a compensation circuit composed of a timing controller, a trigger generator, a starter circuit and a power converter.

The compensation circuit comprises a timing controller for generating at least one signal required by the plurality of gate driver chips; a trigger generator for receiving the at least one signal generated by the timing controller and generating at least one signal; a starter circuit for receiving the at least one signal of the trigger generator so as to generate at least one signal; a power converter for receiving the at least one signal of the starter circuit so as to control the selection of a plurality of output voltage. The display gate driver circuit will input the plurality of compensated output voltages into the plurality of gate driver chips.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a prior art gate driver circuit;

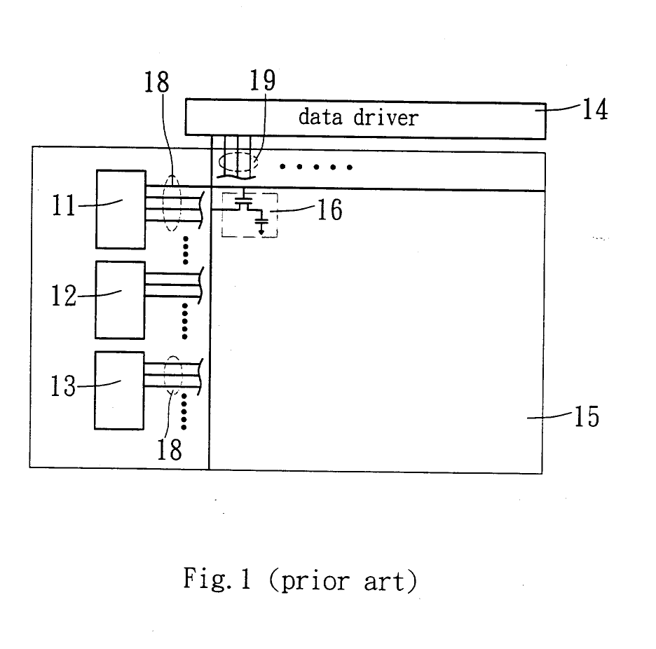

FIG. 2 is a perspective diagram of voltage compensation of a display gate driver circuit and a driving method according to an embodiment of the present invention;

FIG. 3 is a perspective diagram of a compensation circuit of a display gate driver circuit and a driving method according to an embodiment of the present invention;

FIG. 4 is a timing diagram of the operation of the compensation circuit of the display gate driver circuit and driving method according to the embodiment of the present invention; and

FIG. 5 is a flowchart of the operation of the compensation circuit of the display gate driver circuit and driving method according to the embodiment of the present invention.

### DETAILED DESCRIPTION OF THE PREFERRED EMBODIMENT

The display gate driver circuit of the present invention provides a compensation circuit a scheme for decreasing the appearance of the block dims on the display frame of the LCD panel. Because of the wiring resistances of the circuit on the LCD panel, the voltage differences will be generated among the gate driver chips when switching the TFT switches so as to result in the appearance of the block dims among the gate driver chips.

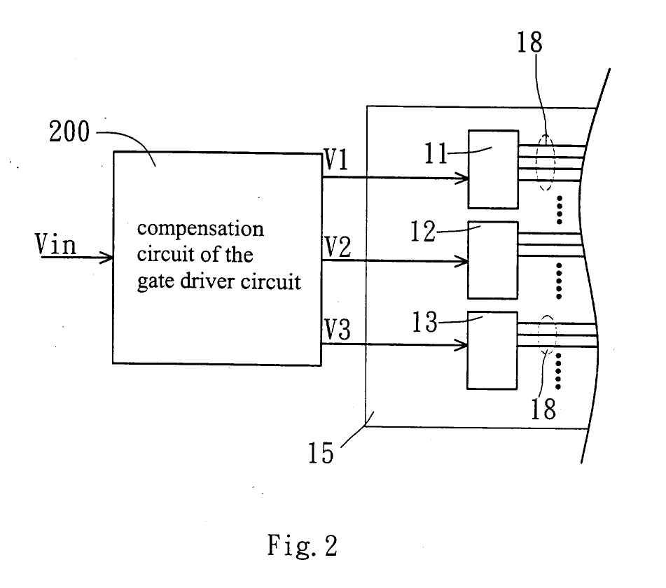

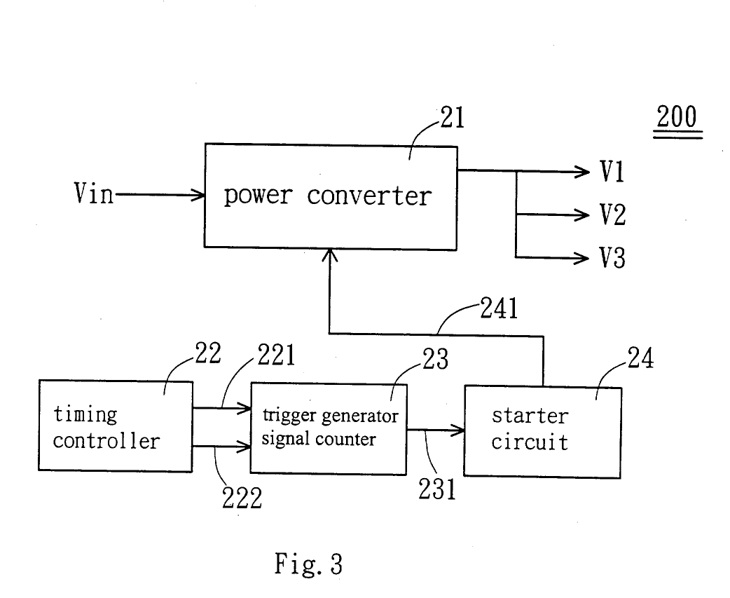

Please refer to FIG. 2 FIG. 2 is a perspective diagram of voltage compensation of a display gate driver circuit and a driving method according to an embodiment of the present invention. The gate driver circuit employs a chip-on-film (COF) scheme; namely, a plurality of gate driver chips 11, 12 and 13 are installed on a TFT panel (thin film transistor panel) of a flexible printed circuit (FPC) board. In the present invention, a compensation circuit 200 is installed in the front of the plurality of gate driver chip 11, 12 and 13 for separately compensating the voltages of the plurality of gate driver chips by inputting the voltage Vin of each of the gate driver chips into the power end. In this embodiment, the voltage is outputted from the power end to the compensation circuit 200. A power converter (as shown in FIG. 3) in the compensation circuit 200 is used for selecting the voltage to be compensated. As shown in the figure, a first output voltage V1 is for the first gate driver chip 11, a second output voltage V2 is for the second gate driver chip 12, and a third output voltage V3 is for the third gate driver chip 13. The plurality of gate driver chips are used for driving the display of the LCD panel 15 by means of the compensated voltage. The present invention employs the driving voltages compensated by the compensation circuit 200 so as to avoid the appearance of the block dims on the display due to the inconsistent voltage droppings.

Please refer to FIG. 3. FIG. 3 is a perspective diagram of a compensation circuit of a display gate driver circuit and a driving method according to an embodiment of the present invention. This embodiment employs a timing controller 22 on the control baseboard of the TFT panel to generate a plurality of signal required by the plurality of gate driver chips shown in FIG. 2. This timing controller 22 is used for controlling the operation timing of each of the driving element on the detecting the display of LCD panel. The generated signal comprises a gate clock pulse 221 and a gate start pulse 222. The plurality of signals are transmitted to the trigger generator and signal counter 23, and then the trigger generator 23 will generate the trigger signal 231 required by the starter circuit 24. This trigger generator 23 further comprises a signal counter. The trigger signal 231 generated by the trigger generator 23 is transmitted to the starter circuit 24. This circuit will further generate an enabling signal 241, and a power converter 21 is used for receiving this enabling signal 241 so as to select the different output levels of the gate voltages on the power converter 21, namely, the first output voltage V1, the second output voltage V2 and the third output voltage V3, and select the output voltage according to the required compensation voltage value.

As shown in FIG. 3, the power converter 21 is used for receiving the input voltage Vin inputted into the LCD panel via the power end. According to the voltage droppings of the gate driver chips 11, 12, 13, a plurality of compensation voltages are generated. The plurality of compensation voltages are used for compensating the inconsistent voltage droppings of the plurality of gate driver chips in the panel due to the resistances. As shown in the figure, the three compensation voltages are the first output voltage V1, the second output voltage V2 and the third output voltage V3. The plurality of output voltages are obtained by calculating the voltage droppings of the gate driver chips due to the resistances and evaluating the required compensation voltage value. The input voltages Vin are processed by the power converter 21 and the enabling signal 241 generate a plurality of compensation voltages V1, V2 and V3 to be inputted to the gate driver chips.

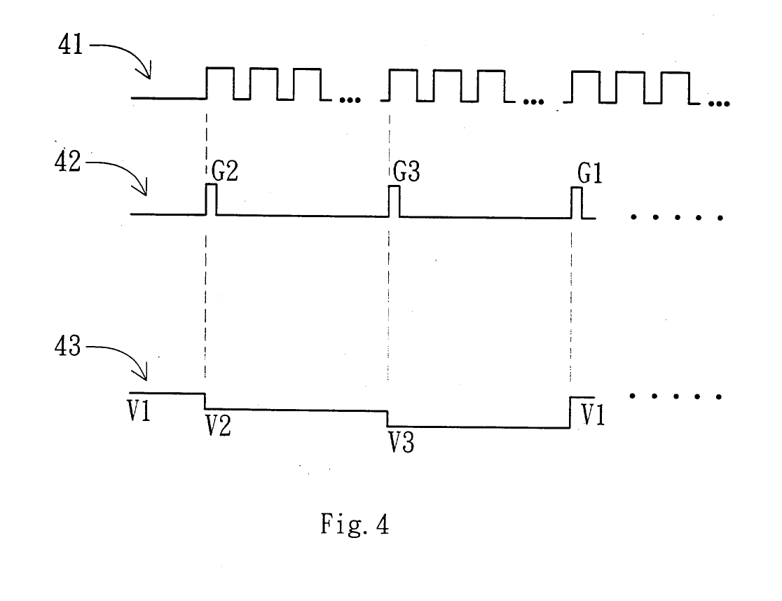

Please refer to FIG. 4 FIG. 4 is a timing diagram of the operation of the compensation circuit of the display gate driver circuit and driving method according to the embodiment of the present invention. FIG. 4 is the timing diagram of the operations of the three gate driver chips 11, 12, 13 in FIG. 2. The gate clock 41 is a gate driver chip operation clock and is controlled by the gate clock pulse 221 transmitted by the timing controller 22 in the compensation circuit (please refer to FIG. 3). The protruding portions of a plurality of pulse waveforms are the gate driving clocks for sequentially initiating a plurality of TFT switches. The gate driver chips are used for driving the thin film transistors of the whole LCD panel (in practical operation, it is not limited to three gate driver chips). The pulses of the gate start pulse 42 are used for initiating the operations of the three gate driver chips. The timing controller 22 will send out the gate start pulse 222 to the trigger generator 23 so as to control the operation of the start pulse. The gate off voltage 43 is a gate voltage level adjusted by using the compensation circuit of the invention, and it is adjusted according to the operation pulse of each of the gate driver chips. Namely, the driving voltage corresponding to the first start pulse G1 for initiating the operation of the first gate driver chip is the first output voltage V1, the driving voltage corresponding to second start pulse G2 for initiating the second gate driver chip is the second output voltage V2, and the driving voltage corresponding to third start pulse G3 for initiating the third gate driver chip is the third output voltage V3.

As shown in FIG. 3, the timing controller 22 transmits a plurality of signal via the trigger generator 23 and the starter circuit 24, and the clock operation signals are transmitted into the power converter 21 by the enabling signal 241 so as to generate the operation clocks shown in FIG. 4.

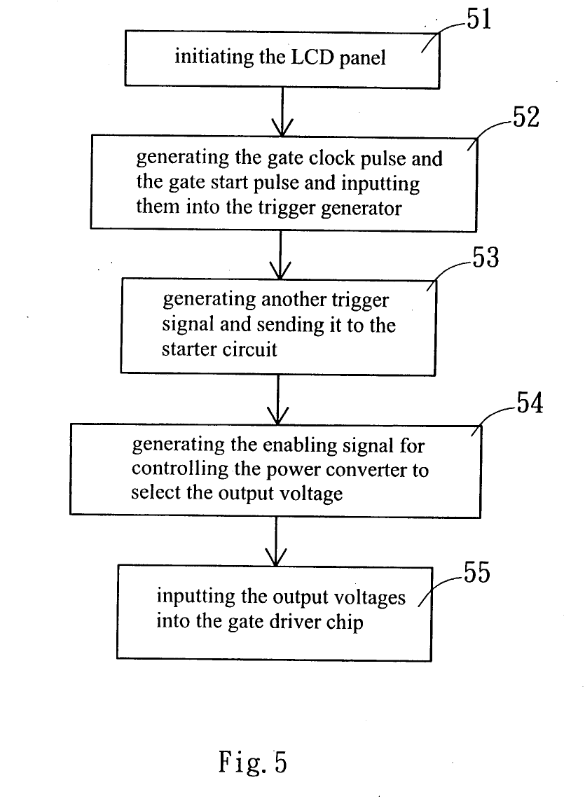

Please refer to FIG. 5. FIG. 5 is a flowchart of the operation of the compensation circuit of the display gate driver circuit and driving method according to the embodiment of the present invention. This flowchart shows a preferred embodiment of the present invention for decreasing the block dims on the LCD panel due to the gate voltage differences caused by the wiring resistances on employing a plurality of gate driver chips in the chip-on-film scheme. The method comprises the following steps.

In the step 51, the LCD panel is initiated, and the gate driver chips will control the plurality of TFT switches. In the step 52, the timing controller 22 will output the gate clock pulse 221 and the gate start pulse 222 which are required by the gate driver chips, and then transmit them into the trigger generator 23. A signal counter is installed in the trigger generator for receiving the gate clock pulse 221 and the gate start pulse 222 outputted by the timing controller 22. In the step 53, another trigger signal 231 is generated and then is inputted into the starter circuit 24 so as to control the power converter 21 to select different gate voltage levels. In the step 54, according to the enabling signal 241 transmitted from the starter circuit 24, the power converter 21 will control and select the driving voltage levels to be compensated for the gate driver chips. For example, the driving voltage levels are the first output voltage V1(V1=gate voltage −ΔV), the second output voltage V2 (V2=gate voltage −2ΔV), and the third output voltage V3 (V3=gate voltage −3ΔV), and are determined according to different design values. In the step 55, each of the output voltages will input into each of the gate driver chips. The gate voltage differences of the plurality of gate driver chips caused by the wiring resistances in the terminals of the LCD panel will be compensated so as to mitigate the appearance of the block dims.

The above is the detailed description of the display gate driver circuit and driving method according to the embodiment of the invention. In the present invention, a gate driving voltage generated by a compensation circuit is input into a plurality of gate driver chips so as to avoid the appearance of the block dims on the LCD panel due to the voltage droppings caused by the resistances. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A compensation device of a display gate driver circuit, the compensation circuit comprising:
a timing controller for generating at least one signal required by a plurality of gate driver chips;
a trigger generator for receiving the at least one signal generated by the timing controller and generating at least one signal;
a starter circuit for receiving the at least one signal of the trigger generator and generating at least one signal;
a power converter for receiving the at least one signal of the starter circuit so as to control the selection of a plurality of output voltages;
wherein the display gate driver circuit will input the plurality of compensated output voltages into the plurality of gate driver chips.

2. The compensation device of claim 1, wherein the signal generated by the timing controller comprises a gate clock pulse and a gate start pulse.

3. The compensation device of claim 1, wherein the signal generated by the trigger generator comprises a trigger signal.

4. The compensation device of claim 1, wherein the signal generated by the starter circuit comprises an enabling signal.

5. The compensation device of claim 1, wherein the trigger generator further comprises a signal counter.

6. The compensation device of claim 1, wherein the power converter is used for receiving an input voltage and outputting the plurality of output voltages.

7. A compensation device of a display gate driver circuit, a compensation circuit being installed on a LCD panel and comprising:
a timing controller for generating a gate clock pulse and a gate start pulse required by a plurality of gate driver chips;
a trigger generator for receiving the gate clock pulse and the gate start pulse generated by the timing controller and generating a trigger signal;
a starter circuit for receiving the trigger signal of the trigger generator and generating an enabling signal;
a power converter for receiving the enabling signal of the starter circuit so as to control the selection of a plurality of output voltage;
wherein the display gate driver circuit will input the plurality of the compensated output voltages into the plurality of gate driver chips so as to compensate the inconsistent voltage droppings of the plurality of gate driver chips due to the resistances.

8. The compensation device of claim 7, wherein the power converter is used for receiving an input voltage and outputting the plurality of output voltages.

9. The compensation device of claim 7, wherein the trigger generator further comprises a signal counter.

10. A compensation method for a display gate driver circuit, a compensation circuit being installed on a LCD panel, the method comprising:
outputting a gate clock pulse and a gate start pulse to a trigger generator;
generating a trigger signal to a starter circuit;
transmitting an enabling signal to a power converter;
controlling the selection of a plurality of driving voltage levels to be compensated for the plurality of gate driver chips by transmitting the enabling signal to the power converter so as to compensate the inconsistent voltage droppings of the plurality of gate driver chips due to the resistances.

11. The compensation method of claim 10, wherein the gate clock pulse and the gate start pulse are generated by a timing controller.

12. The compensation method of claim 10, wherein the trigger generator is used for generating the trigger signal.

13. The compensation method of claim 10, wherein the starter circuit is used for generating the enabling signal.

14. The compensation method of claim 10, wherein the power converter is used for receiving an input voltage and outputting the plurality of driving voltage levels.

15. The compensation method of claim 10, wherein the trigger generator further comprises a signal counter.
